(19) United States
(12) Patent Application Publication
(10) Pub. No.: US 2015/0047985 A1
(43) Pub. Date: Feb. 19, 2015

(54) APPARATUS AND METHOD FOR USING SOLAR RADIATION IN ELECTROLYSIS PROCESS

(71) Applicant: YEDA RESEARCH AND DEVELOPMENT CO., LTD., Rehovot (IL)

(72) Inventors: Jacob Karni, Rehovot (IL); Yury Alioshin, Ashkelon (IL); David Banitt, Tal Shahar (IL); David Scheiner, Savyion (IL); Roi Harpaz, Rehovot (IL); Baruch Finarov, Petach Tikva (IL)

(21) Appl. No.: 14/372,064

(22) PCT Filed: Jan. 13, 2013
(86) PCT No.: PCT/IL2013/050034

§ 371 Date: Jul. 14, 2014

(30) Foreign Application Priority Data
Jan. 12, 2012 (IL) 217507

(51) Int. Cl. C25B 1/00; C25B 9/08; C25B 1/10; C25B 9/18

(52) U.S. Cl. CPC C25B 1/003; C25B 9/18; C25B 9/08; C25B 1/10; C25B 1/00
USPC 205/340; 204/275.1; 204/269; 204/260

(57) ABSTRACT

A solar-driven apparatus is provided having: a cavity having at least one optical window for collecting electromagnetic radiation associated with solar energy impinging on said at least one optical window; a reaction assembly located inside the cavity and adapted to enable carrying out electrolysis process of at least one raw fluid utilizing energy derived partially from the solar radiation and partially from an electric source; one or more ingress units operative to allow introduction of the raw fluid into the apparatus; and one or more egress units operative to allow exit of the electrolysis process' products from the solar driven apparatus.

### FIELD OF THE INVENTION

The present invention relates in general to solar systems used for carrying out chemical reactions, and particularly to solar systems and methods utilizing CO₂ and/or H₂O as their raw materials.

### BACKGROUND OF THE INVENTION

The technologies developed for utilization of abundant intermittent renewable energy resources such as solar and wind energy have reached, or are approaching, acceptable efficiency, reliability and cost levels. However, since these resources are intermittent and there are no cost effective large scale means for storing electricity, solar and wind power are presently not suitable for base-load electricity supply and can only be used in combination with other resources to supply a relatively small portion (5%-20%) of the total power supply. Therefore, the success or failure in commercializing the widespread use of renewable energy resources strongly depends on effective storage means for storing energy derived from renewable resources, and long distance transportation to enable conveying this energy to sites other than those at which the energy is collected.

In order to overcome these drawbacks various methods have been proposed for converting solar energy to chemical potential (i.e. fuel). In general, thermal energy—derived from concentrated solar radiation at a sufficiently high temperature—can be used to induce endothermic chemical reactions resulting in products which may be used on demand to provide the energy contained therein (such as fuels). These products may be stored, transported and consumed in the form of fuel.

At the same time, global CO₂ emission poses a significant threat to the wellbeing of the planet. CO₂ capture and sequestration is being developed as a possible solution, but the proposed solutions for long term CO₂ storage are rather problematic and expensive.

Various processes have been proposed in the art to utilize solar energy in processes which aim to dispose of CO₂ while producing energy rich products. One example of such a process is CO₂ reforming of methane to produce syngas (i.e. synthesis gas-a mixture of hydrogen and carbon monoxide) as follows:

CH₄+CO₂→2CO+2H₂

This process of solar-driven methane reforming to produce clean fuel has been studied extensively and one of the advantages of using it is that it can be reversed to produce energy upon demand, thereby providing the option to operate in a closed loop, and consequently to provide a means for storage and transportation of solar energy.

Another example, high temperature electrolysis using a clean energy source to such as solar radiation, has also been proposed, mainly for the electrolysis of water. Stoots, C. M., O'Brien, J. E., Herring, J. S., Condie, K. G. and Hartvigsen, J. J. “Idaho National Laboratory Experimental Research in High Temperature Electrolysis for Hydrogen and Syngas Production,” Proceedings of the 4th International Topical Meeting on High Temperature Reactor Technology HTR2008, Sep. 28-Oct. 1, 2008, Washington, D.C. USA, maintained that the higher temperature for the electrolysis reduces the amount of electricity required for the process. The authors also disclosed that CO₂ electrolysis can use different metal electrodes, and liquid or solid polymer electrolytes. The maximum efficiency of a non-polluting electrolysis system depends on the efficiency of a clean source electricity system, for example, a photovoltaic-driven system. During electrolysis, carbon may deposit on the electrodes, which decreases their efficiency, and eventually stops the process.

International patent publication WO 10/013244, assigned to the assignee of the present application discloses a system and method for chemical potential energy production. The system comprises a heat source to provide heat at the desired temperature and energy field (e.g. a solar concentrator); an electron source configured and operable to emit electrons; an electric field generator generating an electric field adapted to supply energy sufficient to dissociate gas molecules; and a reaction gas chamber configured and operable to cause interaction between the electrons with the molecules, such that the electrons dissociate the molecules to product compound and ions within the chamber.

### General Description

There is a need in the art for a novel approach capable of providing an adequate solution for efficient, high rate production of clean and low-cost products while utilizing solar energy.

The present invention provides a novel method and apparatus for generating clean electricity using solar energy with cost effective storage allowing per-demand operation, on a continuous basis. The technique of the present invention also provides for reducing CO₂ emission by using it as feedstock for fuel generation. The present invention provides for reducing the need for sequestration of CO2 captured in power plants and other CO2 emitting facilities. Further, the present invention provides for generating a viable and cost competitive alternative for liquid fuel for transportation.

A solar-driven apparatus of the present invention comprises a cavity having at least one optical window to introduce electromagnetic radiation associated with solar energy (e.g. from a solar energy concentrator), and a reaction assembly located inside the cavity adapted to enable carrying out an electrolysis process of raw fluid (typically a gas), such as CO₂, H₂O or a combination thereof. The apparatus also has ingress unit(s) operative to allow introduction of the raw fluid and egress unit(s) operative to allow exit of the electrolysis process' products. The energy required to carry out the electrolysis process of the raw fluid inside the solar-driven apparatus, is derived partially from the solar radiation incident onto the at least one optical window, and partially from an electric source.

The solar-driven apparatus may further comprise a heat-to-electricity (solar-to-electricity) converting unit, operative to convert energy derived from solar radiation into electricity, whether directly from the solar radiation or indirectly via a working fluid that is heated by the solar radiation and in turn is used to heat the heat-to-electricity converting means.

At least part of the energy derived from solar radiation may be stored in a form of chemical energy (e.g. as products of an endothermic reaction), and optionally the stored chemical energy is utilized in a process of generating electricity. In accordance with another embodiment, at least part of the electricity generated by the solar-to-electricity convertor is used in the electrolysis process.

According to some embodiments of the invention, it provides a novel configuration of the reaction assembly inside the cavity. The reaction assembly comprises a plurality of reaction units arranged in one or more arrays in a spaced-apart relationship. The electromagnetic radiation propagates in the cavity towards the reaction units along a solid angle having a general propagation direction. This may be that of the solar radiation entering the cavity via the transparent optical window(s) and directly impinging on the reaction units' arrangement, and/or that of the reflection/diffusion of the solar radiation re-directed from the cavity walls and/or infrared radiation emitted by the cavity walls being heated by the solar radiation.

The arrangement of the cavity (its geometry defined by the arrangement of cavity walls and the at least one optical window) defines the electromagnetic radiation distribution and propagation within the cavity and thus defines an irradiated region of to the cavity with substantially uniform irradiation. Preferably, the reaction units are arranged such as to be substantially uniformly distributed within said region of the substantially uniform irradiation. Such uniform distribution of the reaction units may be achieved by arranging the reaction units substantially symmetrical with respect to the general propagation direction of the electromagnetic radiation inside the cavity. For example, the reaction units are arranged with equal distance between them in an array along at least a segment of a substantially circular (round) path around the general propagation direction of the electromagnetic radiation. According to another example the optical window of the cavity comprises a diffuser, and the electromagnetic radiation entering the cavity is re-directed and re-radiated by the diffuser into a wide range of emitted angles.

Thus, according to one broad aspect of the invention, there is provided a solar-driven apparatus comprising:

a cavity having at least one optical window for collecting electromagnetic radiation associated with solar energy impinging on said at least one optical window,

a reaction assembly located inside the cavity and configured for carrying out electrolysis process of at least one raw fluid utilizing energy derived partially from the solar radiation and partially from an electric source;

one or more ingress units operative to allow introduction of the raw fluid into the apparatus;

one or more egress units operative to allow exit of the electrolysis process' products from the apparatus.

In various embodiments of the cavity and optical window(s) configuration, the reaction assembly is (i) exposed to direct solar radiation entering said cavity via said at least one optical window, and/or (ii) energy reaching the reaction assembly comprises the collected solar radiation that has been re-directed from inner walls of the cavity (e.g. by one or more diffusers) onto the reaction assembly, and/or and infra-red thermal radiation generated from the cavity walls after the latter have been heated by the radiation introduced to the cavity.

The at least one optical window may comprise an opening; and/or transparent element; and/or radiation diffuser(s) adapted to re-direct and re-radiate the incident solar radiation in a wide range of angles.

As indicated above, the cavity with the at least one optical window defines an irradiated region. The reaction assembly may comprise a plurality of reaction units to arranged in a spaced-apart relationship in one or more arrays within the irradiated region. Preferably, the reaction units are arranged such as to be substantially uniformly distributed within said irradiated region, e.g. are arranged substantially symmetrically with respect to a general propagation direction of the radiation propagating towards the irradiated region, e.g. are arranged in one or more circular or linear arrays.

According to some embodiments of the invention, the reaction assembly comprises at least one reaction unit comprising: an inner shell comprising an arrangement of electrodes and a solid membrane, and electrical conductors attached to the reaction unit and adapted to convey electricity for carrying out the electrolysis process. The arrangement of electrodes comprises at least an external electrode and an inner electrode (cathode and anode, either one of them being external and the other being inner electrode). The electrical conductors comprise an inner electrode conductor and an outer electrode conductor, arranged such that the inner electrode conductor is connected to an outwardly facing surface of the inner electrode.

For example, one of the electrodes is located at an outwardly facing surface of the inner shell and the other electrode is located at an inwardly facing surface of the inner shell, and the electrical conductors are located at the outwardly facing surface of the inner shell.

The multi-layer structure of the inner shell of the reaction unit may comprise at least one intermediate layer located between the electrodes and the solid membrane.

The reaction assembly may further comprise an outer shell enclosing the at least one inner shell; at least one ingress utility to enable introduction of gas to be electrolyzed; and at least two egress utilities to enable exit of the process products from the reaction assembly. The multi-layer structure of the inner shell may comprise at least three layers comprising the cathode electrode layer, an electrolyte layer and the anode electrode layer. According to one possible example, the anode is located at the outwardly facing surface of the inner shell and the cathode is located at the inwardly facing surface of the inner shell and the electrical conductors are located at the outwardly facing surface of the inner shell. The reaction assembly may have one of the following configurations: (i) the electrolyte layer forms an inner shell supporting structure, the cathode and anode electrodes' layers being deposited or coated thereon, (ii) the cathode or anode electrode layer forms an inner shell supporting structure, the other layers being deposited thereon. Additionally, the to electric conductors of the cathode and anode electrodes may be located at the same side of an inner shell supporting structure. The electrolyte layer may be made from at least one of the following materials: Yttria-stabilized Zirconia and Gadolinium doped Ceria.

The configuration may be such that the reaction assembly comprises at least one reaction unit adapted to enable carrying out an electrolysis process of CO₂, and at least one reaction unit adapted to enable carrying out an electrolysis process of H₂O.

The configuration may further be such that the reaction assembly comprises at least one reaction unit adapted to enable carrying out an electrolysis process of CO₂ or H₂O or a combination thereof. The reaction assembly may further comprise an ingress utility operative to allow introduction of a carrier gas to the reaction assembly so that it can be mixed with the flow of the O₂ product within the apparatus.

According to another broad aspect of the invention, there is provided a solar-driven reaction assembly, adapted to be located in a solar-driven apparatus and to enable carrying out an electrolysis process of raw fluid therein, the reaction assembly comprising:
at least one inner shell configured as a multi-layer structure comprising at least an external electrode, and inner electrode and a solid membrane between the electrodes;
electrical conductors attached to said inner shell for conveying electricity for carrying out the electrolysis process, the electrical conductors comprising an inner electrode conductor and an outer electrode conductor,
at least one ingress utility to enable introduction of gas to be electrolyzed;
at least two egress utilities to enable exit of the process products.

The configuration may be such that the electrodes are located on opposite sides of the inner shell. The outer electrode conductor is connected to an outwardly facing surface of the outer electrode. As for the inner electrode conductor it may be connected to an outwardly facing surface of the inner electrode or to the inwardly facing surface of the inner electrode.

According to yet another broad aspect of the invention, there is provided a solar-driven apparatus comprising:
a cavity having at least one optical window for collecting electromagnetic radiation associated with solar energy impinging on said at least one optical window, said cavity with the at least one optical window being configured to define an irradiated region,
a reaction assembly located inside the cavity and configured for carrying out an electrolysis process of raw fluid utilizing energy derived partially from the solar radiation and partially from an electric source, the reaction assembly comprising a plurality of reaction units arranged in a spaced-apart relationship in one or more arrays within said irradiated region such as to be substantially uniformly distributed within said irradiated region;
one or more ingress units operative to allow introduction of the raw fluid into the apparatus;
one or more egress units operative to allow exit of the electrolysis process' products from the apparatus.

According to yet further aspect of the invention, there is provided a method for carrying out an electrolysis of CO₂ or H₂O or a combination thereof, in a solar-driven apparatus comprising a cavity having at least one optical window to collect electromagnetic radiation associated with solar energy, and a reaction assembly located inside the cavity for carrying out the electrolysis process, the method comprising:
exposing said optical window to the solar radiation;
introducing raw fluid being CO₂ or H₂O or a combination thereof into said apparatus, thereby causing an electrolysis process where energy required for the process is provided partially from the solar energy and partially from an electric source; and
allowing withdrawal of products obtained in the electrolysis process away from the apparatus.

### BRIEF DESCRIPTION OF THE DRAWINGS

The present invention will be understood and appreciated more fully from the following detailed examples taken in conjunction with the drawing:

FIG. 1 illustrates a schematic representation of solar-driven dissociation of recycled CO₂ to CO and O₂;

FIG. 2 illustrates a schematic representation of solar-driven simultaneous dissociation of water and CO₂;

FIGS. 3A and 3B present schematic layouts of solar-driven apparatus to according to an embodiment of the invention for converting CO₂ (FIG. 3A) and CO₂ and H₂O to syngas, where the reaction units are exposed to direct solar radiation;

FIGS. 4A and 4B present schematic layouts of solar-driven apparatus according to another embodiment of the invention, where the reaction units are exposed to diffused electromagnetic radiation corresponding to solar radiation impinging onto the diffuser at the optical window of the cavity;

FIGS. 5A and 5B present schematic layouts of a solar-driven apparatus according to yet another embodiment of the invention for converting CO₂ (FIG. 5A) and CO₂ and H₂O to syngas (FIG. 5B), where the reaction units are not exposed to direct solar radiation;

FIG. 6 presents a number of different reaction units having different cross sections;

FIG. 7 demonstrates an example of various array arrangements for reaction units of different cross sections in the solar driven apparatus;

FIG. 8 demonstrates an example of arrays' arrangement of tubular reaction units in a solar driven apparatus;

FIGS. 9A and 9B illustrate two schematic cross section of a reaction unit, where electrical conductors are arranged differently in both FIGs;

FIG. 10 illustrates a schematic cross section of a reaction unit with its outer shell; and

FIGS. 11A and 11B illustrate a schematic cross section of a reaction unit with its outer shell and various ingress and egress units of the inner shell.

### DETAILED DESCRIPTION OF THE EMBODIMENTS

The present invention will be understood and appreciated more fully from the following detailed examples taken in conjunction with the drawings.

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a thorough understanding of the to present invention. It should be apparent, however, that the present invention may be practiced without these specific details, or while using other details.

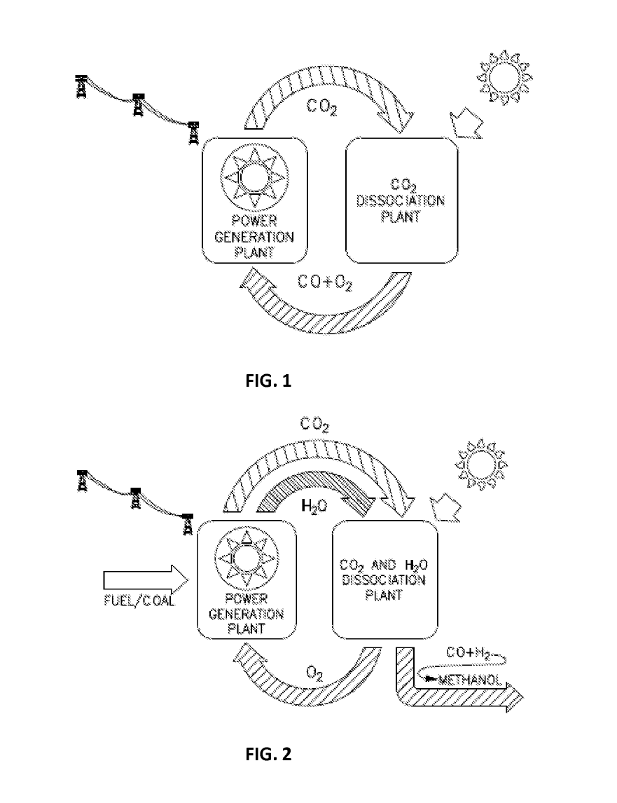

FIG. 1 illustrates a schematic representation of solar-driven dissociation of recycled CO2 emitted from a power plant, to CO and O2. Oxy-fuel combustion of the CO with oxygen produced in the process eliminates the need for exhaust gas scrubbing and separation following the combustion. In the process illustrated in FIG. 1, the CO₂ dissociation products, i.e. CO and O₂, are fed back to the power generation plant, replacing the original fuel.

The advantages of such a method are:
The solar energy is driving a large scale power block, preferably combined cycle stations, hence, benefiting from their very high efficiency;
Energy storage is available (storage of gaseous fuel) at low cost and by using off-the-shelf means;
Clean power generation-reducing pollution by use of oxy-fuel Combustion;
Reducing CO₂ emission at low cost while replacing the expensive and potentially dangerous sequestration;
Eliminating the need of CO₂ separation from other emitted gases, since the product of oxygen and CO combustion is relatively clean CO₂.

FIG. 2 illustrates a schematic representation of solar-driven simultaneous dissociation process of water and CO₂. The water dissociates into H₂ and O₂, and the CO₂ into CO and O₂. The O₂ in this example is returned to a power plant for oxy-combustion as a fuel, while the CO and H₂ are reacted to produce methanol, a well-known and qualified replacement to gasoline, which can be stored, transported and used in motor vehicles. In the alternative, the mixture of CO and H₂ (syngas) may be used as a source of energy. In both alternatives, the oxygen produced in the dissociation process may be used for oxy-fuel combustion in power plants.

Let us now consider for example a case where CO₂ is dissociated to CO and O₂, carried out together with a dissociation process of H₂O to H₂ and O₂. The working temperature is between 600° C. and 1200° C. The molar ratio of CO to H₂ is controlled during the process and the mixture (syngas) can then be used directly as gaseous fuel (e.g. in power or chemical plants), or be converted into methanol or other liquid hydrocarbons, which can be used as transportation fuels.

In order to simplify the discussion, the following examples will be described to with reference to the dissociation of CO₂ by way of high-temperature electrolysis, even though such examples are also relevant for dissociation of H₂O (or a combination of CO₂ and H₂O) by way of high-temperature electrolysis.

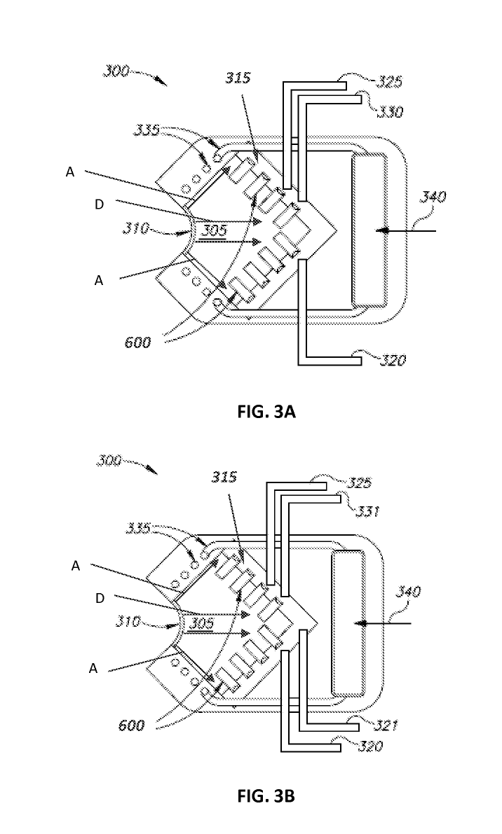

Reference is now made to FIGS. 3A and 3B illustrating a conceptual layout of a solar-driven apparatus 300 according to an embodiment of the invention for converting CO₂ to CO and O₂, (FIG. 3A) which may similarly be used for converting H₂O to H₂ and O₂ (mutates mutandis) or for converting CO₂ and H₂O to syngas (FIG. 3B). The apparatus 300 includes a cavity 305 which has an optical window (e.g. opening) 310 through which solar radiation enters the cavity 305. Provided inside the cavity 305 is a reaction arrangement, generally at 315, which in the present example is formed by a plurality of reaction units 600, which are directly exposed to electromagnetic radiation, being either the solar radiation that entered the cavity via the optical window or reflection/diffusion thereof from the cavity walls and/or infrared radiation emitted by the cavity walls being heated by the solar radiation. In the present example of FIGS. 3A and 3B, the optical window 310 is either an opening or a transparent plate and thus the reaction arrangement is directly exposed to the collected/introduced solar radiation.

As shown in FIG. 3A, the received electromagnetic radiation propagates in the cavity with a solid angle denoted by arrows A and has a general propagation direction D, thus defining an irradiated region inside the cavity. The reaction arrangement (array(s) of reaction units) is aligned with the irradiated region of the cavity. Preferably, the optical window and the geometry of the cavity are configured to provide substantially uniform irradiation within the irradiated region, and the multiple reaction units 600 are arranged such as to be substantially uniformly distributed within the irradiated region, as will be described more specifically further below.

The (concentrated) solar radiation enters the cavity 305 via the optical window 310 and hits the reaction units 600 directly, thereby providing a substantial portion of the energy required to reach the desired operating conditions (temperature, flux distribution, etc.). One of the major advantages in having a set up where direct concentrated solar radiation reaches reaction units 600 is, that it enables achieving highest temperatures and improved energy efficiency. Another portion of energy provided to the reaction units is obtained from the radiation re-directed from the cavity walls either as diffusive solar radiation or as infra-red thermal radiation generated from the cavity walls after the latter have been heated by the solar radiation to introduced to the cavity.

Further provided in the apparatus 300 are ingress unit 320 for feeding reaction materials into the apparatus 300 and egress units 325 and 330 for withdrawal of electrolysis products from the apparatus. Thus, CO₂ is fed into the apparatus via the ingress unit 320 and is conveyed to reaction arrangement 315 either via a header (not shown in this Figure) or by using any other applicable means known in the art per se. It should be noted that the reaction units 600 may be configured either in a serial flow arrangement or in a parallel flow arrangement or a combination thereof, where the plurality of reaction units may relate either to all the reaction units comprised in the solar driven apparatus, or to groups of reaction units, each comprising a certain number (not necessarily equal for all the groups) of reaction units.

The electrolysis products are then withdrawn from apparatus 300 as O₂ (via egress unit 325) and CO (or a combination of CO and the non-dissociated CO₂) through egress unit 330.

At the same time when the CO₂ dissociation takes place, non-reacting gas is circulated via pipes 335. This gas, which can be non-reacting CO₂ or any other applicable gas (e.g. air), is heated up (in this example mostly by re-directed radiation) and upon heating, is optionally circulated in the cavity and conveyed to heat-to-electricity convertor 340 for generating electricity or any other form of transferable energy. The electricity thus generated may in turn be used as part of the energy required to carry out the electrolysis process, the part derived from electrical source. The electricity needed for the electrolysis process can also be provided partially or in full by an external solar generated source such as photovoltaic cells. A similar process mutates mutandis is shown in FIG. 3B for converting CO₂ and H₂O to syngas, where additional H₂O ingress unit 321 is added and is conveyed to reaction arrangement 315 while syngas is removed through egress unit 331.

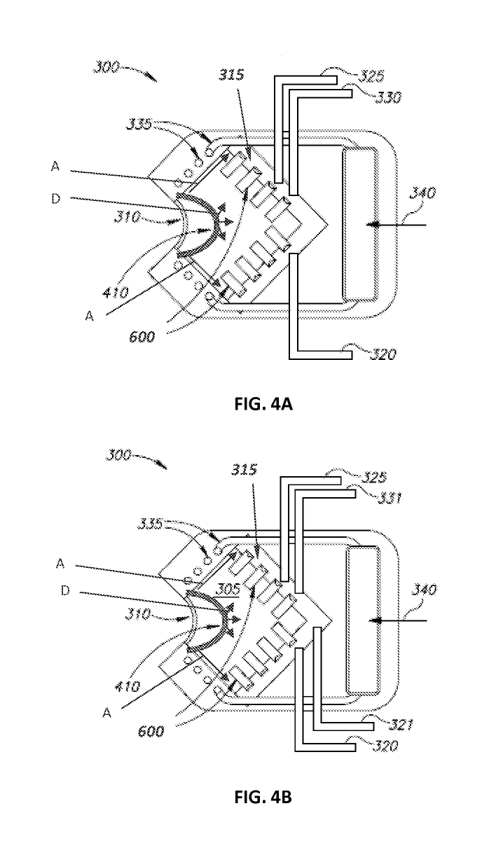

FIGS. 4A and 4B demonstrate another example of solar-driven apparatus of the invention which is configured generally similar to that illustrated in FIGS. 3A and 3B, respectively, where the major difference is the provision of a radiation diffuser 410 in the optical window. One of the major roles of this radiation diffuser is to re-radiate the impinging concentrated solar radiation in a wide range of angles in order to enable a better distribution of the radiation reaching the reaction units 600. The received electromagnetic radiation propagates in the cavity with a solid angle denoted to by arrows A and has general propagation directions D, thus defining an irradiated region inside the cavity. The advantage of this set up is in reducing thermal gradients which might be caused by narrow angle direct radiation that the reaction units of the example illustrated in FIGS. 3A-3B will experience. This solution acts to reduce both spatial and temporal temperature gradients and thus reduce thermal stress in the reaction units and cavity. Furthermore, this solution enables use of a higher number of reaction units within the cavity than the configuration illustrated in the examples of FIGS. 3A-3B due to larger angular distribution of radiation from the diffuser which reduces shadowing effects in comparison to the case of direct irradiation. Thus, in the example of FIGS. 4A-4B, the optical window is formed by radiation diffuser 410 and also, optionally a glass window 310 at the entrance opening in order to contain the gas within the cavity.

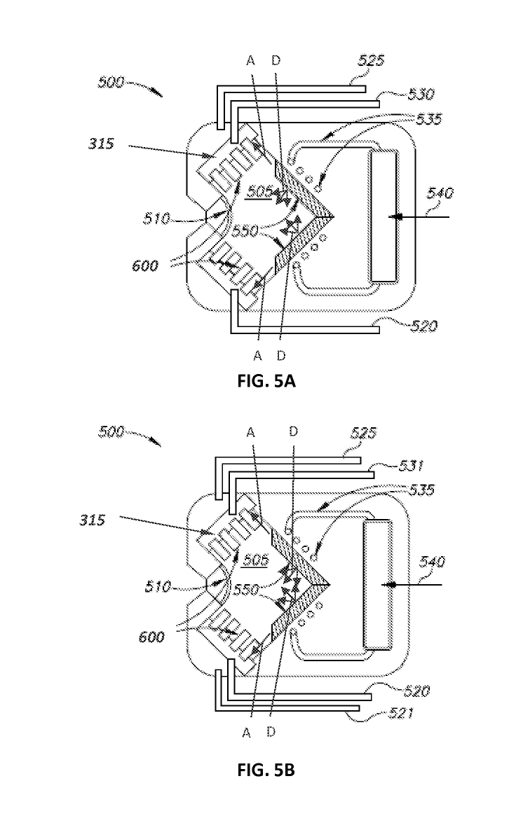

FIGS. 5A and 5B present a schematic layout of a solar-driven apparatus 500 according to yet another embodiment of the invention. The apparatus 500 includes a cavity 505 formed with an optical window 510 and containing a reaction assembly 315 in the form of a plurality of reaction units 600; and has an ingress unit 520 and egress units 525 and 530, as well as circulation pipes 535, and heat-to-electricity convertor 540. Contrary to the previously described examples, in this example, the reaction units 600 are arranged such that they are out of optical path of solar radiation entering the cavity through the optical window 510 and they are thus essentially not exposed to direct solar radiation. The radiation reaching the reaction units and thus contributing to the electrolysis process is provided by the solar energy which enters the cavity and is re-directed by the cavity walls with a solid angle of propagation denoted by arrows A and general propagation directions D towards the reaction units 600 as explained above (i.e. diffusive radiation reflected from the cavity walls and the infra-red radiation emitted from the heated walls of the cavity). The advantage of this set up is that it is helpful in reducing thermal gradients which can be caused by narrow angle direct radiation that the reaction units of the example illustrated in FIGS. 3A-3B will experience. Preferably but not necessarily, radiation diffusers 550 are installed adjacent to one or more of the rear walls of cavity 505, in order to enhance the amount of energy that eventually may reach reaction units 600. The size and shape of radiation diffusers 550 preferably depends on various design considerations. Again, as discussed with connection to FIGS. 4A-4B, this solution also enables use of a higher number of reaction units within the cavity than the configuration illustrated in the to examples of FIGS. 3A-3B due to larger angular distribution of re-directed radiation which reduces shadowing effects in comparison to the case of direct irradiation.

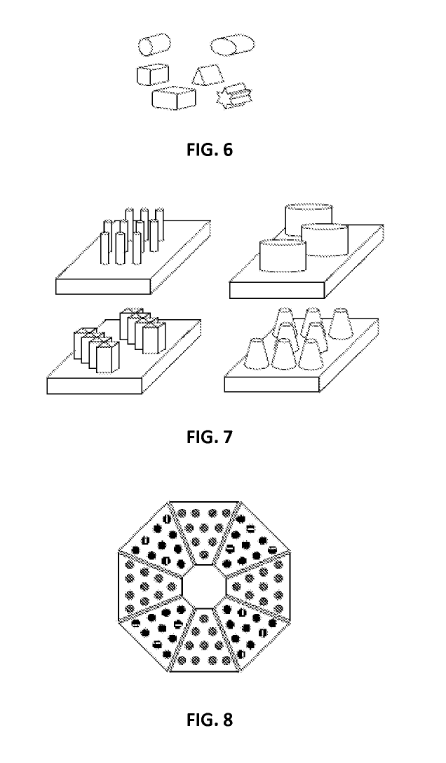

Referring to FIG. 6, there is exemplified a number of different reaction units having different shapes, such as those of substantially rectangular (e.g. square) cross section, circular cross-section, triangular or any other polygonal cross-section.

FIG. 7 illustrates a number of options of arrangements of differently shaped reaction units, e.g. shown in this figure are isometric views of blocks that comprise reaction units in the shape of tubes, conical structures, prisms having various cross-sections such as polygonal (e.g. triangular), oval, circular, etc. The reaction units may be of any suitable height, and are arranged in a spaced apart relationship forming any suitable pattern.

As indicated above, the reaction units are preferably arranged such as to be substantially uniformly distributed within an irradiated region of the cavity. The irradiated region is in turn defined by the optical window and/or arrangement of the cavity walls re-directing the incident/emitted radiation. Such uniform distribution may be achieved for example by arranging the reaction units in an array along at least a segment of a substantially circular (round) path with equal distance between the units. FIG. 8 shows an example of arrays' arrangement of tubular reaction units in the solar driven apparatus.

The reaction units in the solar-driven apparatus may be arranged so that the electrolysis products H₂ and CO are produced in different (separate) reaction units. The electrolysis products can subsequently be combined, either directly at the egress of the solar driven apparatus or at a downstream location. The molar mixing ratio of the constituent gases may be controlled to ensure the production of syngas. Alternatively, the reaction units in the solar-driven apparatus may be provided with a mixture of CO₂ and H₂O so that the electrolysis products H₂ and CO are produced together in the reaction units. The electrolysis products are thus combined. The molar mixing ratio of the incoming raw gases may be controlled to ensure the production of syngas.

Although the above disclosure has been illustrated by way of applying tubular reaction units made of certain materials, it should be understood that the present invention is not restricted to such materials or configuration and may be applied to other designs as well, mutates mutandis.

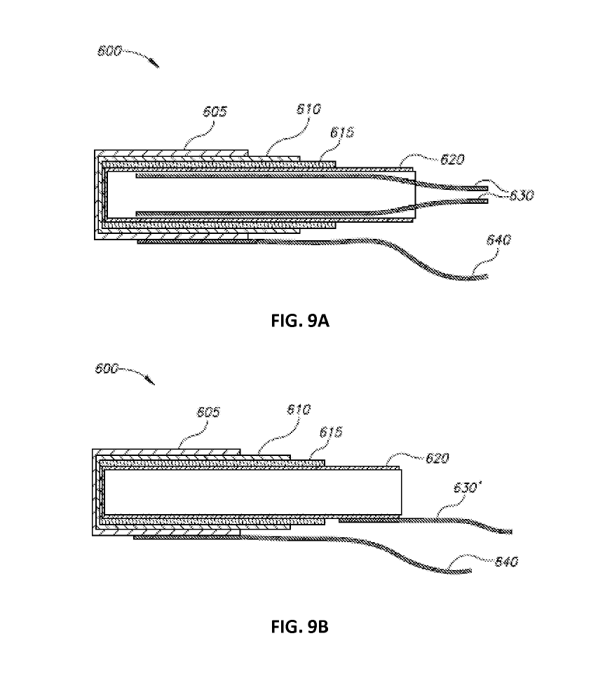

Reference is now made to FIGS. 9A and 9B illustrating an example of the to configuration of a reaction unit 600 of the present invention suitable to be used in the above-described examples of solar-driven apparatus. More specifically, these figures illustrate a schematic cross section of the inner shell of the reaction unit 600, for carrying out an electrolysis process using a solid membrane. The membrane may be solid-oxide such as YSZ or Gadolinium doped Ceria, for example.

The inner shell of the reaction unit 600 is a multi-layer structure defining an arrangement of electrodes. In this specific but not limiting example, the reaction unit is an essentially 3-layers structure which comprises an external electrode 605, a membrane 615, and an inner electrode 620, and may optionally include one or more intermediate layers 610 between the electrodes and the membrane. Also, the present invention is independent of which of the electrodes (i.e. the cathode and the anode) is the external electrode and which of them would be the inner electrode.

In addition, an arrangement of electrical conductors is provided being attached to the inner shell 600 for conveying electricity for carrying out the electrolysis process. The electrical conductors include at least one inner electrode conductor and at least one outer electrode conductor.

In some examples, the electrodes are located on opposite sides of the inner shell. In some other examples, the outer electrode conductor is connected to an outwardly facing surface of the outer electrode and the inner electrode conductor is connected to an outwardly facing surface of the inner electrode.

As shown in these specific not-limiting examples of FIGS. 9A and 9B, electrical conductor 640 (outer electrode conductor) is connected to the surface of the external electrode 605, and inner electrode electrical conductors 630 or 630′ (FIGS. 9A or 9B respectively) are connected to the surface of the inner electrode 620, being the inwardly facing surface of electrode 620 in the example of FIG. 9A and the outwardly facing surface of the inner electrode 620 in the example of FIG. 9B.

As will be appreciated by those skilled in the art, one of the major technical problems associated with solar dissociation of the raw fluid in a process that requires energy received from both solar source and electrical source, involves the conductance of electrical current to the reaction unit under high solar flux/heat, to which these reaction units are exposed. In FIGS. 9A and 9B two examples are illustrated for locating the inner electrode's conductors. The above technical problem is further intensified in the presence of high O₂ concentration due to its strong to corrosive properties. If for example, the raw fluid is introduced from outside the inner shell in the arrangement illustrated in FIG. 9A, the inner electrode conductor 630 is exposed to a corrosive O₂ fluid flowing through the inner part of the shell. Locating the inner electrode conductor 630′ on the outwardly facing surface of the inner electrode 620 as in FIG. 9B, reduces this problem.

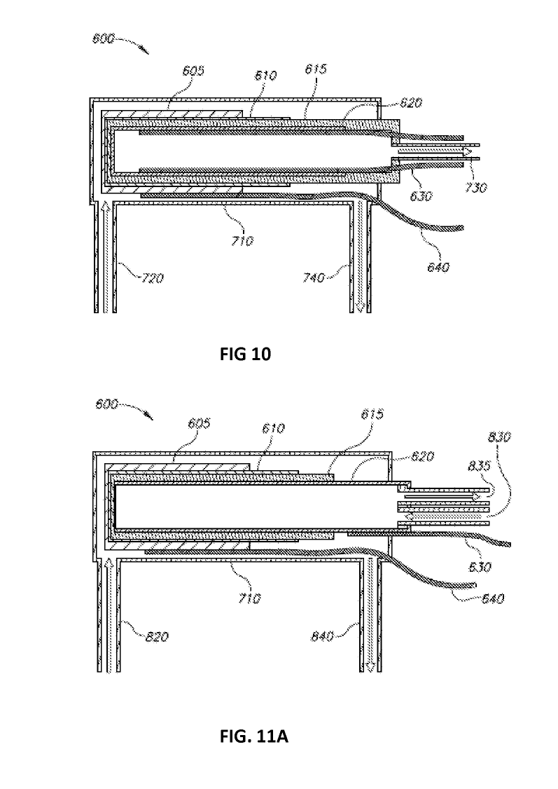

FIG. 10 illustrates a schematic cross section of the reaction unit shown in FIG. 9A. As may be seen in this specific but non-limiting example, the reaction unit 600 may further comprise an outer shell 710 (which can contain/convey the fluid and provide control of the flow around the surface of the inner shell and may optionally serve also as a radiation shield).

As further exemplified in FIG. 10, the reaction unit 600 includes an ingress utility 720 for the incoming CO₂ (and/or H₂O) raw gas, and two egress utilities (e.g. tubes) 730 and 740 for conveying the electrolysis products O₂ (egress 730) and CO or CO/CO₂ (and H₂ or H₂/H₂O in case of H₂O dissociation) (egress 740). Naturally, for different designs, tube 740 may serve as the ingress utility while tube 720 as the second egress utility. It should be noted that the present invention also encompasses cases where the CO₂ ingress refers in fact to ingress of CO+CO₂ mixture, having substantially low CO concentration, and/or the CO and H2 egress refers in fact to a CO/CO₂ and H₂/H₂O mixture, having substantially high CO concentration and H₂ as well. The external electrode conductor 640 may be connected through the outer shell or it may be connected directly to a conductive outer shell (not shown).

Let us consider now an example where the reaction units are of a substantially tubular shape having outer shell through which the raw fluid flow is conveyed while interacting with the external electrode. The external electrode may be the cathode over which CO₂ or H₂O flows, whereas the internal electrode is an anode which “emits” oxygen into the central tube. The outer shell comprises two fluid connections: an ingress pipe for the CO₂ and an egress pipe for CO/CO₂ mixture. As explained above, the ingress pipe may be used to convey low CO concentration there through and the egress pipe may convey high concentration of CO. In addition, the combination of the CO₂/CO/O₂ gases may be replaced or mixed with H₂O/H₂/O₂, respectively. Obviously, the arrangement of cathode and anode of this example may be reversed, provided an additional ingress is added to the inner tube.

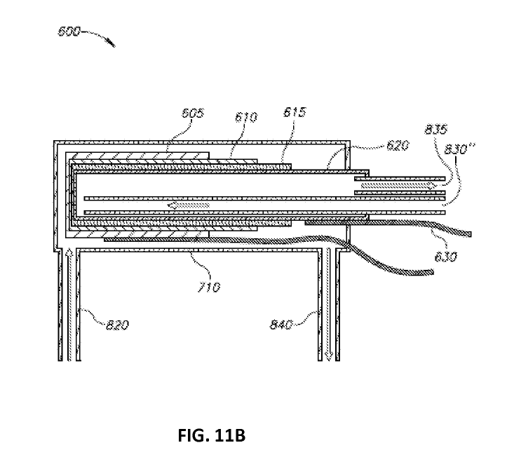

FIG. 11A illustrates a reaction unit 600 which is generally similar to the above-described example, but in which the raw gas CO₂ (and/or H₂O) is fed into the inner to volume of the reaction unit via ingress utility 830, while the electrolysis product(s) CO (and/or H₂) are removed via egress utility 835, whereas the O₂ is collected from the inner space of the outer shell via egress utility 840. In a specific embodiment, exemplified in FIG. 11B, the ingress or egress utility associated with the inner volume is a long tube whereby the raw gas is fed via a feed-tube 830″ and the CO/H₂ product collected from the surrounding volume by egress utility 835. In an alternative, the direction of flow is reversed whereby the raw gas is fed into the surrounding volume while the CO/H₂ product is collected by a collection-tube (not shown).

In some embodiments of the invention the O₂ electrolysis product is emitted into a non-flammable carrier gas such as air, nitrogen, CO₂ or the like supplied by optional ingress utility 820. This non-flammable carrier gas may be beneficial in reducing thermal gradients at the reaction units due to conduction and convection. It may also be of help in lowering corrosion caused by the O₂ product, by reducing the O₂ partial pressure. Later on, the O₂ may be separated from the carrier gas, if needed, at another downstream process station.

It should be noted, although not specifically shown, that the configuration may be such that the reaction assembly includes one or more groups of reaction units, where the reaction units of the group includes multiple (generally at least two) inner shells all located within a common outer shell. Each of these inner shells may be associated with separate ingress and egress utilities such that each inner shell is separately provided with the raw fluid, while the common outer shell may be connected either to a single common ingress utility or to multiple ingress utilities and may be connected to either a single common egress utility or to multiple egress utilities. As will be appreciated by those skilled in the art, the arrangement of cathode and anode of this embodiment may be reversed, whereby the raw fluid is introduced within the outer shell and the O₂ product is collected from a plurality of egress utilities associated with each of the plurality of inner shells.

It is to be understood that the present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It should be noted that some of the above described embodiments describe the best mode contemplated by the inventors and therefore include structure, acts or details of structures and acts that may not be essential to the invention and which are described as examples. Structure and acts described herein are replaceable by equivalents which perform the same function, even if the structure or acts are different, as known in the art, e.g. the use of a processor to carry out at least some of the functions described as being carried out by the detector of the present invention. Therefore, the scope of the invention is limited only by the elements and limitations as used in the claims. When used in the following claims, the terms “comprise”, “include”, “have” and their conjugates mean “including but not limited to”.

1. A solar-driven apparatus comprising:
a cavity having at least one optical window for collecting electromagnetic radiation associated with solar energy impinging on said at least one optical window,
a reaction assembly located inside the cavity and configured for carrying out electrolysis process of at least one raw fluid utilizing energy derived partially from the solar radiation and partially from an electric source;
one or more ingress units operative to allow introduction of the raw fluid into the apparatus;
one or more egress units operative to allow exit of the electrolysis process' products from the apparatus.

2. The apparatus of claim 1, further comprising a heat-to-electricity converting means, operative to convert energy derived from solar radiation into electricity.

3. The apparatus of claim 2 whereby a fluid is circulated and heated in said cavity and conveyed to said heat-to-electricity convertor for generating electricity.

4. (canceled)

5. The apparatus of claim 2, wherein at least part of the electricity generated by the heat-to-electricity convertor is used in the electrolysis process.

6-8. (canceled)

9. The apparatus of claim 1, wherein said at least one optical window comprises at least one of the following: an opening; a transparent element; a radiation diffuser adapted to re-direct and re-radiate the incident solar radiation in a wide range of angles.

10. The apparatus of claim 1, wherein said cavity with the at least one optical window is configured to define an irradiated region, the reaction assembly comprising a plurality of reaction units arranged in a spaced-apart relationship in one or more arrays within said irradiated region.

11. (canceled)

12. The apparatus of claim 10, wherein the reaction units are arranged substantially symmetrically with respect to general propagation directions of the radiation propagating towards the irradiated region.

13. The apparatus of claim 1, wherein said reaction assembly comprises a plurality of reaction units arranged in a spaced-apart relationship in one or more arrays, which is located out of the optical path of direct solar radiation entering the cavity, whereby radiation reaching the reaction units is provided by the solar energy which enters the cavity and is then re-directed towards said reaction units.

14. The apparatus of claim 1, wherein the reaction assembly comprises at least two reaction units, wherein at least one of the reaction units is configured for carrying our first electrolysis process of a first raw fluid, and at least one other reaction unit is configured for carrying our second electrolysis process of a second raw fluid.

15. The apparatus of claim 1, wherein the reaction assembly comprises at least one reaction unit adapted to enable carrying out an electrolysis process of CO2, and at least one reaction unit adapted to enable carrying out an electrolysis process of H2O.

16. (canceled)

17. The apparatus of claim 1, wherein the reaction assembly comprises at least one reaction unit comprising: an inner shell comprising an arrangement of electrodes and a solid membrane, and electrical conductors attached to the reaction unit and adapted to convey electricity for carrying out the electrolysis process, wherein the arrangement of electrodes comprises at least an external electrode and an inner electrode, and the electrical conductors comprise an inner electrode conductor and an outer electrode conductor.

18. The apparatus of claim 17, wherein one of the electrodes is located at an outwardly facing surface of the inner shell and the other electrode is located at an inwardly facing surface of the inner shell.

19. (canceled)

20. The apparatus of claim 17, wherein the outer electrode conductor is connected to an outwardly facing surface of the outer electrode, the inner electrode conductor being connected to either an outwardly facing surface of the inner electrode or an inwardly facing surface of the inner electrode.

21. The apparatus of claim 17, wherein said inner shell of the reaction unit comprises at least one intermediate layer located between the electrodes and the solid membrane.

22. (canceled)

23. The apparatus of claim 17, wherein said multi-layer structure of the inner shell comprises at least three layers comprising the cathode electrode layer, an electrolyte layer and the anode electrode layer.

24. (canceled)

25. The apparatus of claim 23, having one of the following configurations: (i) the electrolyte layer forms an inner shell supporting structure, the cathode and anode electrodes' layers being deposited or coated thereon, (ii) the cathode or anode electrode layer forms an inner shell supporting structure, the other layers being deposited thereon.

26-27. (canceled)

28. The apparatus of claim 23, wherein the reaction assembly further comprises an ingress utility operative to allow introduction of a carrier gas to the reaction assembly so that it can be mixed with the flow of the O2 product within the apparatus.

29. A solar-driven reaction assembly, adapted to be located in a solar-driven apparatus and to enable carrying out an electrolysis process of raw fluid therein, the reaction assembly comprising:
at least one inner shell configured as a multi-layer structure comprising at least an external electrode, and inner electrode and a solid membrane between the electrodes;
electrical conductors attached to said inner shall for conveying electricity for carrying out the electrolysis process, the electrical conductors comprising an inner electrode conductor and an outer electrode conductor;
at least one ingress utility to enable introduction of gas to be electrolyzed;
at least two egress utilities to enable exit of the process products.

30. The reaction assembly of claim 29, wherein the outer electrode conductor is connected to an outwardly facing surface of the outer electrode, and the inner electrode conductor is connected to either an outwardly facing surface of the inner electrode or an inwardly facing surface of the inner electrode.

31-32. (canceled)

33. A method for carrying out an electrolysis of at least one of CO2, H2O, or a combination thereof, in a solar-driven apparatus comprising a cavity having at least one optical window to collect electromagnetic radiation associated with solar energy, and a reaction assembly located inside the cavity for carrying out the electrolysis process, the method comprising:
exposing said optical window to the solar radiation;
introducing raw fluid being at least one of CO2 and H2O into said apparatus, thereby causing an electrolysis process where energy required for the process is provided partially from the solar energy and partially from an electric source; and
allowing withdrawal of products obtained in the electrolysis process away from the apparatus.

34. The method of claim 33, further comprising converting some of the energy derived from the solar radiation into electricity.

35-36. (canceled)
